(19) United States
(12) Patent Application Publication
(10) Pub. No.: US 2019/0303779 A1
(43) Pub. Date: Oct. 3, 2019

(54) DIGITAL WORKER MANAGEMENT SYSTEM

(71) Applicant: Walmart Apollo, LLC, Bentonville, AR (US)

(72) Inventors: Chris Van Briggle, Bentonville, AR (US); Blake Hazelwood, Centerton, AR (US)

(21) Appl. No.: 16/370,653

(22) Filed: Mar. 29, 2019

Related U.S. Application Data
(60) Provisional application No. 62/652,000, filed on Apr. 3, 2018.

(51) Int. Cl. G06N 5/04; G06F 11/07; G06F 11/14; G06F 9/448

(52) U.S. Cl. CPC G06N 5/043; G06F 9/4494; G06F 11/1438; G06F 11/0712

(57) ABSTRACT

Examples of the disclosure provide a system and method for monitoring and controlling Robotic Process Automation (RPA) that may use digital worker robots (bots) having differing reporting and control schemes. A bot manager monitors and consolidates inputs from different types of bots, translates performance and control inputs, and passes data to databases or other applications. A standard data structure may be used, in some embodiments, to enable auditing, reporting, analytics, work intake, and work assignments, to seamlessly operate bots from multiple providers. Disclosed systems and methods may thus coordinate bots among numerous tasks, business units, regions and priorities, even when bots had been designed with inconsistent protocols, such as may occur when using multiple different third party development tools or sourcing bots from different RPA providers.

### BACKGROUND

Robotic process automation (RPA) may use software robots (bots), possibly along with artificial intelligence (AI), for process automation. Whereas with traditional workflow automation, a software developer produces a list of actions to automate a task and interfaces to other systems using application programming interfaces (APIs) or dedicated scripting languages, with RPA systems, a bot may be trained by observing a user perform a task, perhaps in an application's graphical user interface (GUI). Once trained, a bot may then perform an automated process by repeating those tasks in a virtual workstation environment, interpreting a virtual screen display information and issuing mouse and keyboard commands to the application.

### SUMMARY

Examples of the disclosure provide systems and methods for monitoring and controlling robotic process automation (RPA) that may use digital worker robots (bots) having differing reporting and control schemes. A bot manager monitors and consolidates inputs from different types of bots, translates performance and control inputs, and passes data to databases or other applications. A standard data structure may be used, in some embodiments, to enable auditing, reporting, analytics, work intake, and work assignments, to seamlessly operate bots from multiple providers. Disclosed systems and methods may thus coordinate bots among numerous tasks, business units, regions and priorities, even when bots had been designed with inconsistent protocols, such as may occur when using multiple different third-party development tools or sourcing bots from different RPA providers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for robotic process automation (RPA) operations.

FIG. 2 is an exemplary block diagram illustrating a robot (bot) management architecture.

FIG. 3 is an exemplary block diagram illustrating bot management components architecture and message routing.

FIG. 4A is an exemplary chart illustrating a possible work assignment process flow.

FIG. 4B is an exemplary flow chart illustrating a method that may be used to accomplish with the work assignment process of FIG. 4A.

FIG. 5 is an exemplary block diagram illustrating message routing during an alert condition.

FIG. 6A is an exemplary flow chart illustrating a method that may be used to respond to the alert condition illustrated in FIG. 5.

FIG. 6B is an exemplary block diagram illustrating one possible resolution of the alert condition illustrated in FIG. 5, using the method of FIG. 6A.

FIG. 6C is an exemplary block diagram illustrating another possible resolution of the alert condition illustrated in FIG. 5, using the method of FIG. 6A.

FIG. 7 is an exemplary block diagram illustrating an operating environment for a computing device implementing RPA.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

Referring to the figures, examples of the disclosure enable systems and methods for monitoring and controlling robotic process automation (RPA) that may use digital worker robots (bots) having differing reporting and control schemes. A bot manager monitors and consolidates inputs from different types of worker bots (WBs), translates performance and control inputs, possibly into standard data structures, and passes data to databases or other applications. The standard data structure may be used, in some embodiments, to enable auditing, reporting, analytics, work intake, and work assignments, to seamlessly operate bots from multiple providers. Disclosed systems and methods may thus coordinate bots among numerous tasks, business units, regions and priorities, even when bots had been designed with inconsistent protocols, such as may occur when using multiple different third-party development tools or sourcing bots from different RPA providers.

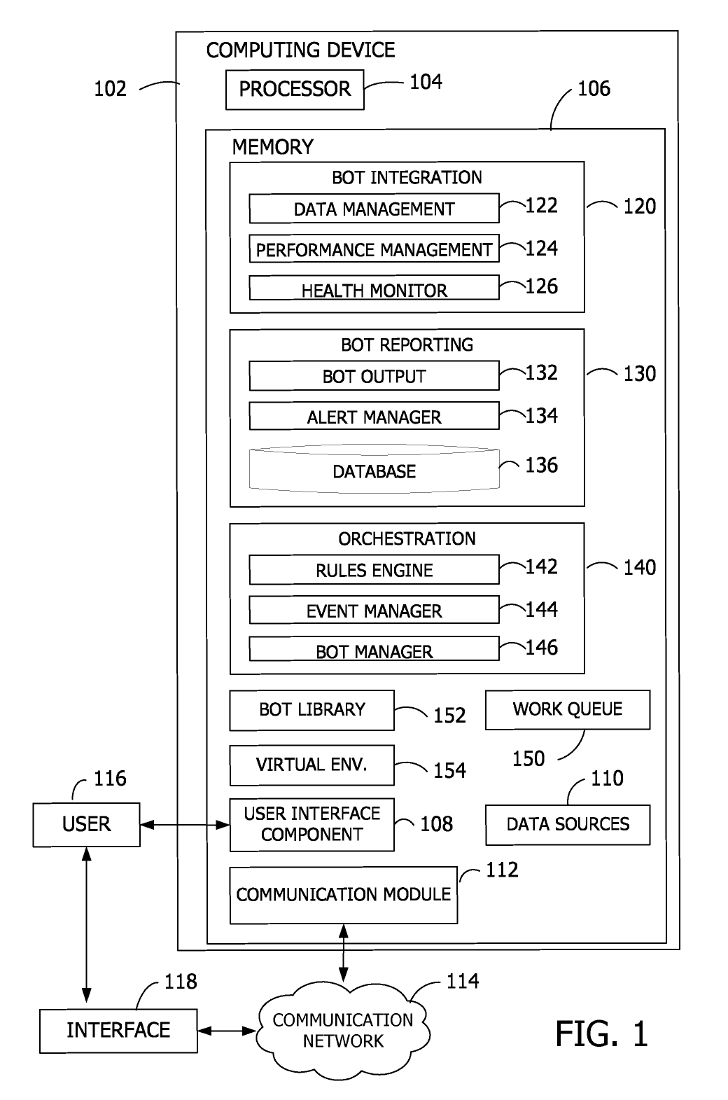

FIG. 1 is an exemplary block diagram illustrating a computing device 102 for RPA using bots. In the example of FIG. 1, computing device 102 may represent one or more of a system for bot management, reporting, orchestration, storing or operating a worker bot environment (possibly using virtual desktop infrastructure (VDI)), communication, or storing or running other services. Computing device 102 represents any device executing instructions (e.g., as application programs, operating system functionality, or both) to implement the operations and functionality as described herein. Computing device 102 may include a mobile computing device or any other portable device. In some examples, a mobile computing device includes a mobile telephone, laptop, tablet, computing pad, netbook, gaming device, wearable, and/or portable media player. In some embodiments, computing device 102 may also represent less portable devices such as desktop personal computers, servers, kiosks, tabletop devices, and industrial control devices. Additionally, computing device 102 may represent a group of processing units or other computing devices.

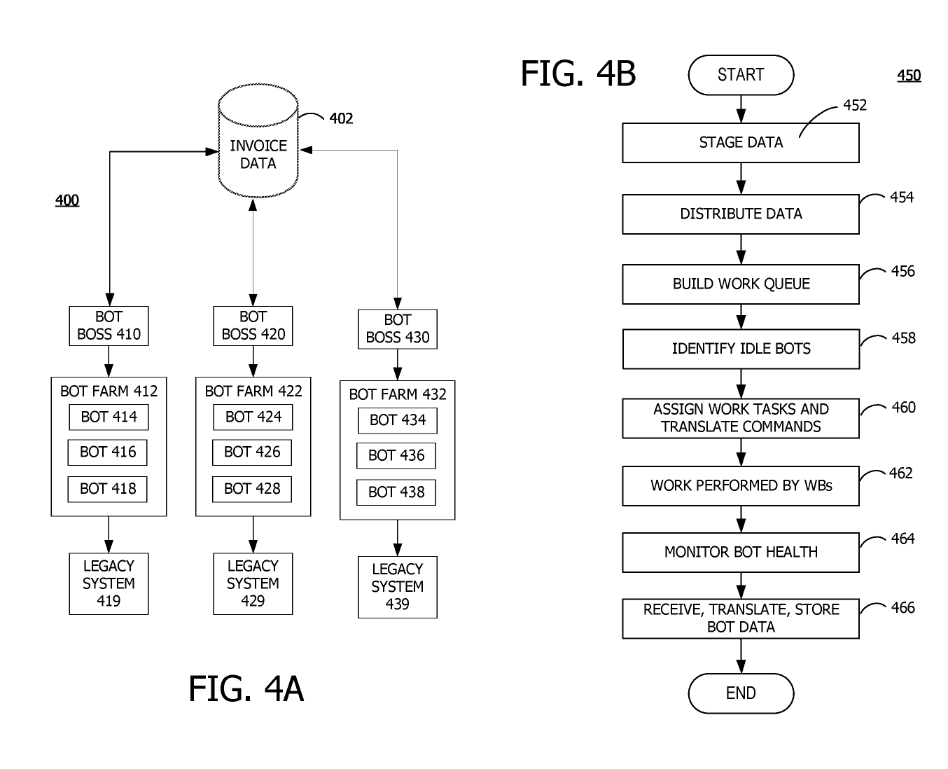

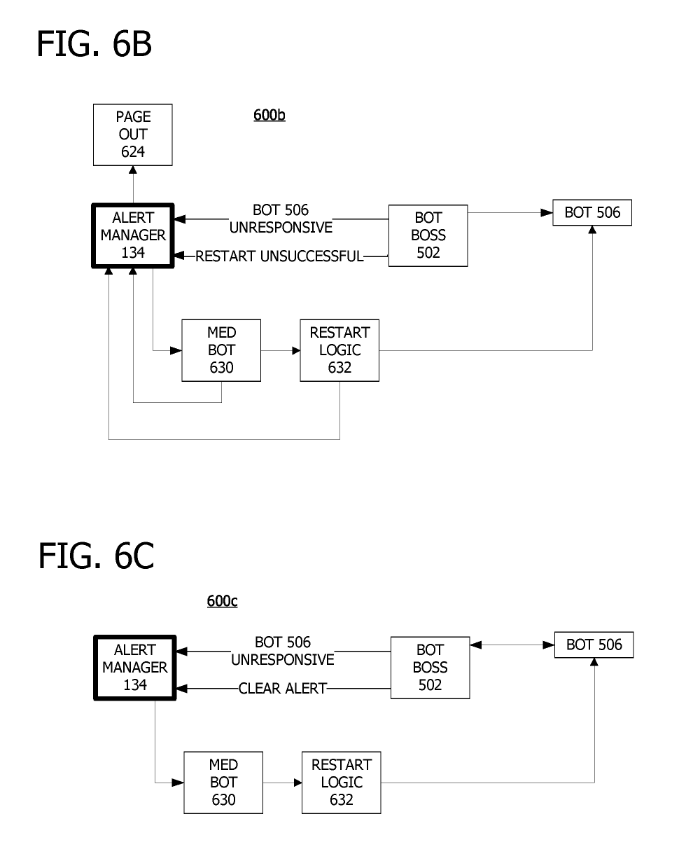

In some examples, computing device 102 has at least one processor 104, a memory area 106, and at least one user interface component 108. Processor 104 includes any quantity of processing units, and may be programmed to execute computer-executable instructions (or logic) for implementing aspects of the disclosure. Executable instructions may be performed by the processor or by multiple processors within computing device 102, or performed by a processor external to computing device 102. In some examples, processor 102 is programmed to execute instructions or logic such as those illustrated in the figures (e.g., FIG. 4B and FIG. 6A).

In some examples, processor 104 represents an implementation of analog techniques to perform the operations described herein. For example, the operations may be performed by an analog computing device and/or a digital computing device.

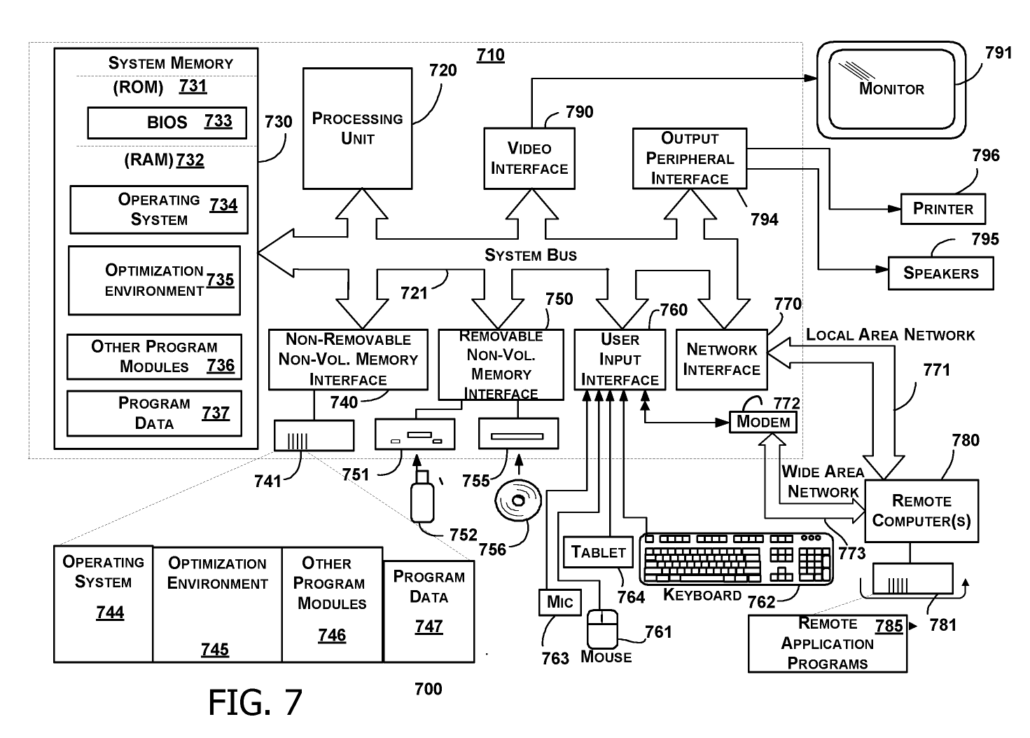

Computing device 104 further has one or more computer-readable media such as memory area 106. Memory area 106 includes any quantity of non-transitory computer-readable media associated with or accessible by the computing device. Memory area 106 may be internal to the computing device (as shown in FIG. 1), external to the computing device (see FIG. 7 and its explanation below), or both. In some examples, memory area 106 includes read-only memory and/or memory wired into an analog computing device.

Memory area 106 stores, among other data, one or more applications comprising executable logic. The applications, when executed by the processor, operate to perform functionality on the computing device. Exemplary applications include bot integration functionality 120; bot reporting functionality 130; orchestration functionality 140; WB library 152; a virtual environment 154 (possibly using VDI); user interface component 108, which may include a graphical user interface (GUI); and logic for a communication module 112. Memory area 106 may also store data used in support of the disclosed operations, such as a work queue 150 and data sources 110. Data sources 110 may represent data stored locally within memory 106, data access points or other pointers indicating data stored remotely from computing device 102, or any combination of local and remote data.

In some examples, WB library 152 stores copies of bots that may be called (manifested as an instance) to process work tasks listed in work queue 150. Typically, a bot may run in a virtual workstation, provided by the functionality of virtual environment 154. Some examples of virtual environment 154 may provide a virtualized version of user interface component 108 with which a bot may interact. In some examples, WB library 152 additionally stores translation information that will permit translation from a standard or common task format into the format needed by a particular bot, and will also permit translation from the particular reporting format of a bot to a standard data format for storing and coordinating work among bots. Because of this translation capability, it may be possible for one bot to take as input the output of another bot's work, even if the bots do not have compatible protocols.

The various applications may communicate with counterpart applications or services such as web services accessible via a communication network 114. For example, the applications may represent downloaded client-side applications that correspond to server-side services executing in a cloud. Communication module 112 may also include hardware components, such as one or more of the following to provide data to and receive data from the communication network 114: a Bluetooth® communication module, a WiFi communication module, an infrared or other radio communication module, and global positioning system (GPS) hardware. Communication network 114 may include the internet, a private network, a wide area network (WAN), a local area network (LAN) or another type of network suitable for computing device 102 to communicate with other devices.

User interface component 108 may also include one or more of the following to provide data to the user 116 or receive data from user 116: speakers, a sound card, a camera, a microphone, a vibration motor, one or more accelerometers, a photoreceptive light sensor, a mouse, and a keyboard. User interface component 108 may also include a radio frequency identification (RFID) transmitter/receiver, a barcode scanner, or any other system that is suitable for output or input. Hardware components, executable logic or both may provide functionality.

In some examples, user interface component 108 includes a graphics card for displaying data to user 116 and receiving data from user 116. User interface component 108 may also include computer-executable instructions (e.g., a driver) for operating the graphics card. Further, user interface component 108 may include a display (e.g., a touch screen display or natural user interface) and/or computer-executable instructions (e.g., a driver) for operating the display. For example, user 116 may input commands or manipulate data by moving computing device 102 in a particular way. In another example, user 116 may input commands or manipulate data by providing a gesture detectable by user interface component 108, such as a touch or tap of a touch screen display or natural user interface. In some examples, some portions of user interface component 108 may be virtualized to operate within virtual environment 154 that runs bots from WB library 152.

In some examples, user 116 may interact with the system of computing device 102 via communications network 114 using interface 118. Interface 118 may be a user interface component of another computing device communicatively coupled to communication network 114, for example.

### Exemplary Operating Methods

An exemplary system may include hundreds of bots (WBs) operating on dozens of different processes, including robotic data entry, requiring differing translations. A single WB may be manifested within a VDI that is running RPA software. Bots may be defined (encoded) for specific processes, with different bots each having potentially unique protocols or formats for control and reposting. Some tasks may be shifted among different bots, but only among those that have the proper capabilities. Different tasks or processes may have different priority levels (e.g., critical, high, medium, and low), based on the expected impact to operations. Some bots may be configured to run only a single task or process, other bots may be configured to run multiple ones.

Unfortunately, different RPA bots from different providers or even bots developed using different tools (even if from the same provider) may use different protocols or formats, and not interact or function compatibly. Currently, different providers each build their own proprietary rapid automation (RA) software solutions that provide in-software process mapping, development and bot monitoring. However, as the industry continues to evolve and different proprietary RA solutions continue to emerge, if an RPA user partners with multiple providers, the result may be disjointed integration points for data visibility, checkpoint restarting, and bot performance monitoring (e.g., alerts and controls).

Thus, an integration management platform is needed to translate tasking, alerts, and reporting among bots and provide clear data, alerting and controls between other systems. Together, the disclosed bot integration functionality 120, bot reporting functionality 130, and orchestration functionality 140 can provide that needed functionality, and are able to manage digital workers (the WBs) by monitoring and consolidating inputs and outputs to/from different types of bots, translating performance and control inputs, passing data to databases or other applications, and acting on alerts.

Bot integration module 120, establishes an integration management platform to translate between bots (i.e. digital workers) and provide clear data, alerting and controls translation among multiple systems. In some examples, bot integration functionality 120 includes data management component 122, performance management component 124, and health monitor component 126. Bot reporting functionality 130 passes data to the appropriate databases or applications, and in some examples, may provide a standard data structure to enable auditing, reporting, analytics, work intake, work assignment to seamlessly operate bots having different protocols. Some examples of bot reporting functionality 130 include bot output 132, an alert manager 134, and a database 136 (which may include multiple databases having differing content and format). Orchestration functionality 140 takes in data input from the various bots and provides central management. Orchestration functionality 140 may be platform agnostic, and thus able to obtain data from multiple different systems that each maintains a unique protocol. In some examples, orchestration functionality 140 includes a rules engine 142, an event manager 144, and a bot manager 146.

In some examples, bot data management 122 accepts data inputs in the various formats of the different bot providers (and RA tools) and translates the data inputs into a standard format that will be sent to centralized databases for performance and controls reporting, such as possibly database 136. Translations from different bots may be different (i.e., different translations may be used) if different bots use different control/reporting formats or protocols. Standard sets of data may be collected from the bots (such as bot_ID and work time), translated, and stored in a centralized database, such as database 136. However, data management 122 may also accept and store process-specific or project-specific data points. Bot performance management 124 manages incoming work to keep the bots busy, such as by identifying idle bots and flagging them to bot management 122. In some examples, performance management 124 provides APIs so that work may be added to a work queue (such as work queue 150) from other systems. A form of “crawler” functionality may also be provided, within performance management 124 or another module, to identify idle resources and systems needing to assign work to a bot.

In some examples, bot integration functionality 120 will ping bots, perhaps at predetermined intervals or upon demand from user 116, to ensure up-time and performance monitoring. In the event that a bot is nonresponsive, health monitor 126 may send an alert to alert manager 134.

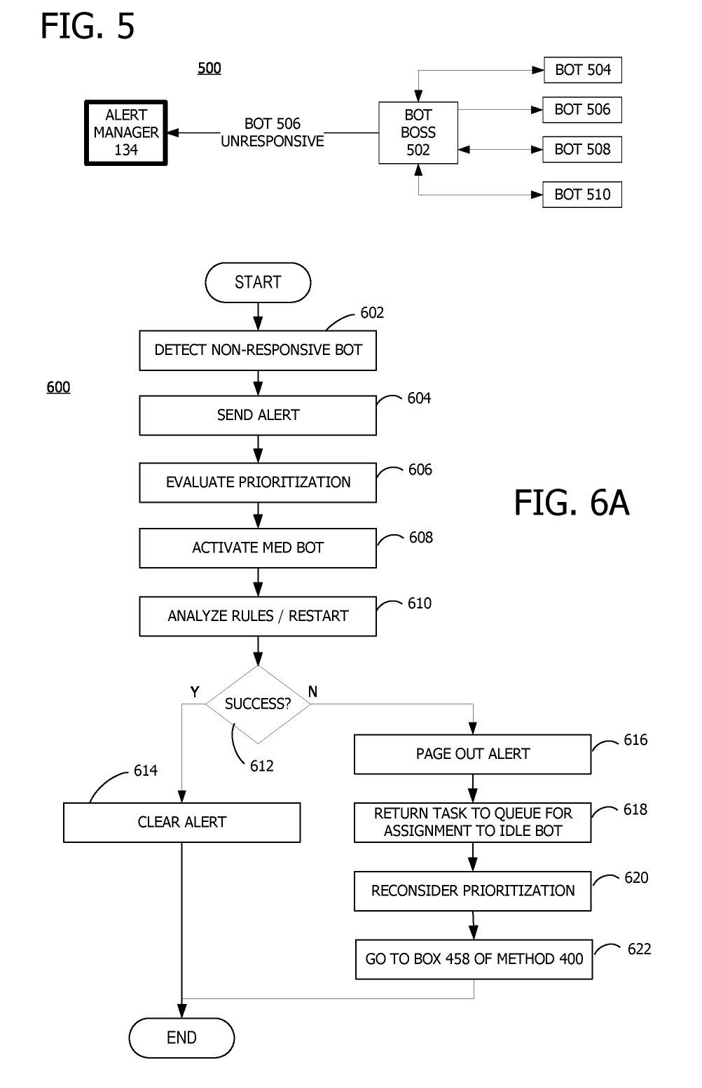

In some examples, bot output 132 hands-off completed work (by a digital worker, a.k.a. a WB) that is ready for a human worker to complete. A bot may only automate a component of an entire work task, leaving a final validation check or other further actions to be taken by a human worker. In some examples, bot alert manager 134 receives issued alerts from bot integration functionality 120 (specifically, health monitor 126). The alert is assigned a specific type, such as (1) down bot, (2) slow bot, (3) failed process, or another type. Based on the alert type, alert manager 134 prescribes an appropriate remedial action. In some event cases alert manager 134 may issue a systemic restart of the subject bot. If sufficiently severe events occur (such as a bot fails to restart), alert manager 134 will send a page out alert, indicating a request for support team intervention. Further details will be provided in the descriptions of FIGS. 5, 6A, and 6B.

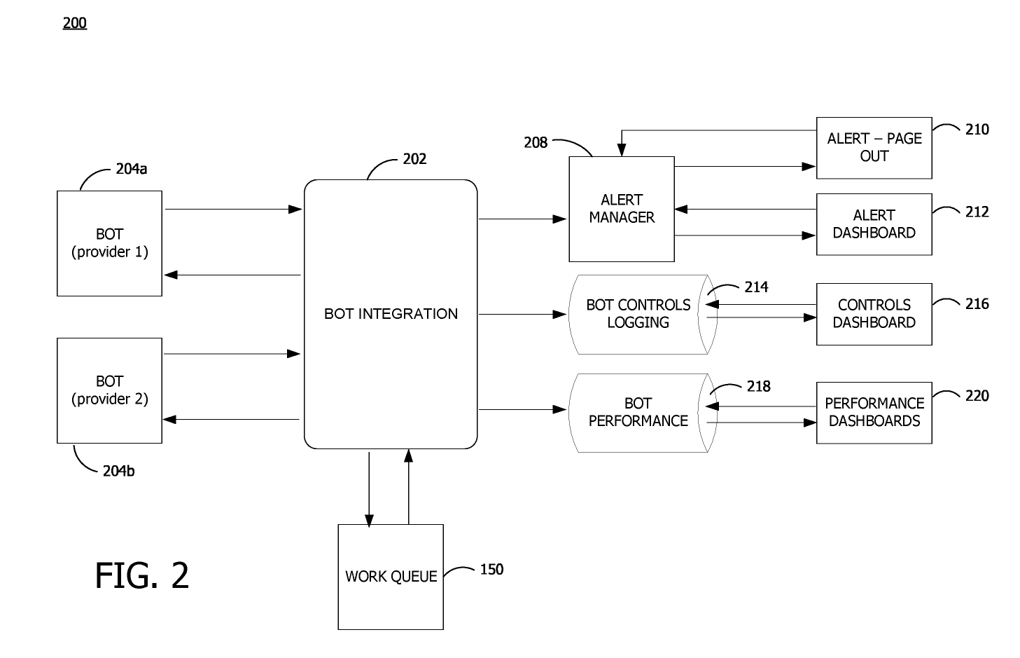

Database 136 is illustrated as a single database, but may include multiple databases, with differing content and format. As bot integration functionality 120 passes data from bots to databases, including database 136, it may optionally perform data translations. Some examples of database 136 may include a portion for controls (see bot controls logging database 214 in FIG. 2), which stores control-centric data. Examples of such control data may include system log-ins, actions that a particular bot accomplished while in the system, timestamping, and data actions taken. Some additional examples of database 136 may include a portion for performance (see bot performance database 218 in FIG. 2), which stores standard and project specific data points for the bots. Examples of such performance data may include bot runtime, bot_ID, project workloads, and volumes processed.

In some examples, event manager 144 receives updates when a bot is about to begin a task (i.e., the bot is acknowledging receipt of the task instructions), when it has completed the task, and possibly at defined intervals while working on the task. Event manager 144 may include a configurable time interval specification which, if exceeded without an update from a bot, may result in the generation of an alert. In some examples, bot manager 146 provides an integration point to (1) monitor bot health, (2) consolidate/translate/standardize data formats, and (3) centralize reporting for bot performance. Bot manager 146 may use custom APIs for event calls to certain bots. In some examples, the translation data may be stored in bot library 152, although other storage locations are possible.

In some examples, rules engine 142 may be employed by orchestration functionality 140 to determine which task to assign to which bot. In addition to worker bots (WBs), there may also be boss bots that control the actions of the other bots, such as WBs. More detail is provided on boss bots in the description of FIG. 4A. One set of exemplary rules may include:

1. Process priority definitions:
a. Critical;
b. High;
c. Medium; and
d. Low.
   2. Configurable time interval, T
   3. Methods to create queue items:
a. Bot manager 146 may be configured to monitor database tables or work queue 150 for new work items.
b. WBs may be assigned to collect queue items from user interface component 108.
   3. A set of API may be available for an application or program to create new items in work queue 150.
   4. Bot management rules:
a. Assign queue item by process priority. First-in-first-out (FIFO) applies within each priority:
   i. Critical items go to the top of the overall queue.
   ii. High priority items go in the second grouping.
   iii. Medium priority items go in the third grouping.
   iv. Low priority items go in the last grouping.
b. Escalate queue items, based on exceeding T (the defined time interval):
   i. High priority items not completed by time T move to Critical priority.
   ii. Medium priority items not completed by time T move to High priority.
   iii. Low priority items not completed by time T move to Medium priority.
c. Distribute work to WBs:
   i. When a WB finishes processing its current task, it becomes available for being assigned a new task.
   ii. Available WBs poll work queue 150 or bot manager 146 for the next task.
   iii. Bot manager 146 returns the highest ranked item in work queue 150 that the available WB is authorized to process based on the WB's operating environment.
   iv. If a new work task is not available, the available WB will check the queue at specified intervals (perhaps T, or a different time interval), until a new task is available.

FIG. 2 is an exemplary block diagram illustrating a bot management architecture 200 that may advantageously use the above-described rules to manage RPA bots. The illustrated example of architecture 200 includes a bot integration module 202, which may be similar to bot integration functionality 120 and may optionally also include some of the functionality described for bot reporting functionality 130, and orchestration functionality 140 (elements 120, 130, 140 shown in FIG. 1). Bot integration module 202 is shown as being in communication with two bots, bot 204a and bot 204b. Bots 204a and 204b may have been retrieved from bot library 152 (of FIG. 1). As annotated, bot 204a and bot 204b were sourced from different providers, indicating that they may use different protocols and data formats for controls, alerts, and reporting.

Thus, bot integration module 202 contains the functionality to send each of bots 204a and 204b commands in the specific appropriate format, and to translate retrieved status updates and results into a standard format for reporting and storage. Bot integration module 202 is also in communication with work queue 150. Bot integration module 202 retrieves work items from work queue 150, to assign as tasks to one or more of bots 204a and 204b, as well as updates work queue 150 to indicate which tasks have been assigned, which tasks have changed priority, and perhaps also to add new tasks.

Bot integration module 202 is further in communication with an alert manager 208, which may be similar to alert manager 134 (of FIG. 1). Bot integration module 202 sends alert messages to alert manager 208, which then forwards the alerts to either a page out alert 210 or an alert dashboard 212. In some examples, only certain relatively serious alerts are sent to page out alert 210, whereas alert dashboard 212 may provide monitoring of most (or all) alerts, including minor alerts. As indicated, page out alert 210 and alert dashboard 212 both provide feedback to alert manager 208, such as, for example, to cancel, silence, or suppress certain alerts. In some examples, alert manager 208 may be part of bot integration 202, and in other examples, alert manager 208 may be separate from bot integration 202.

Bot integration module 202 is in yet further communication with a bot controls logging database 214 and a bot performance database 218. As described previously, bot controls logging database 214 and a bot performance database 218 may be portions of database 136 (of FIG. 1). Bot controls logging database 214 may store control-centric data such as system log-ins, actions that a particular bot accomplished while in the system, timestamping, and data actions taken. Bot performance database 218 may store standard and project specific data points for the bots, such as bot runtime, bot_ID, project workloads, and volumes processed.

As indicated, bot controls logging database 214 is in communication with a controls dashboard 216, which may configure or define data storage requirements for bot controls logging database 214, as well as retrieve data for display to a user (such as perhaps user 116 of FIG. 1). Similarly, bot performance database 218 is in communication with a performance dashboard 220, which may configure or define data storage requirements for bot performance database 218, as well as retrieve data for display to a user.

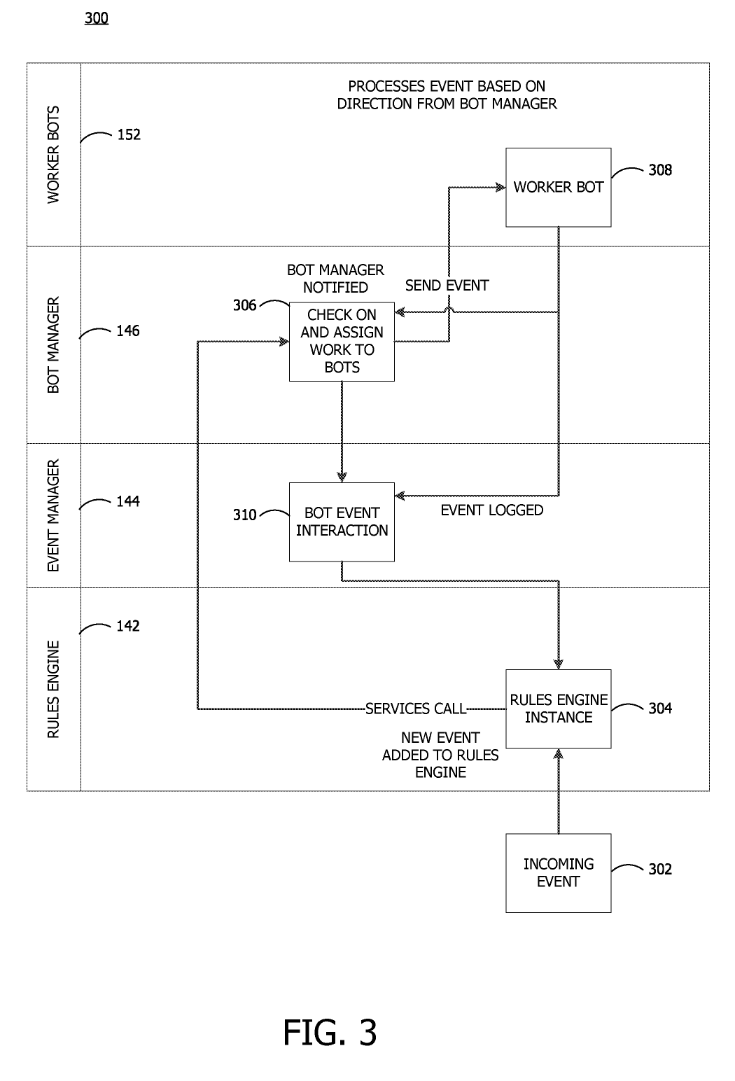

FIG. 3 is an exemplary block diagram illustrating bot manager components architecture 300 and message routing within architecture 300. The illustrated portions of architecture 300 include rules engine 142, event manager 144, bot manager 146, and WBs 152 (a bot library). Together, rules engine 142, event manager 144, and bot manager 146 may be an example of orchestration functionality 140 (of FIG. 1).

As indicated in FIG. 3, an incoming event 302 begins the messaging sequence. Incoming event 302 could be a query of rules engine instance 304 (which is an executing instance of rules engine 142) or could be a configuration change for rules engine instance 304 (for example, a new rule pushed to rules engine instance 304).

An exemplary message sequence may be started by an incoming event 302 such as an invoice exception process. For example, some automated process matching systems used by an operator of an RPA system may match invoice items to received items, identifying invoice items or received items that have no match. The items lacking a match may be placed into an exception queue, and the RPA bot system automates the exception handling. The exception queue is passed into rules engine instance 304 (via incoming event 302). Rules engine instance 304 prioritizes the work, perhaps by ascertaining whether resolving the exception queue has a higher priority than other work that is already within the work queue (such as work queue 150 of FIG. 1). Rules engine instance 304 makes a services call to bot manager 146 to assign the exception queue to a WB in process box 306. Using process box 306, bot manager 146 assigns the task (i.e., sends an event) to an instance of a bot, WB 308, retrieved from WB library 152. WB 308 begins working on the task and pings event manager 144 in bot event interaction 310, to inform event manager 144 that it is processing the exception queue task. At specified time intervals, WB 308 further pings event manager 144 to inform event manager 144 that WB 308 is continuing to operate. Upon completion, WB 308 informs both bot manager 146 and event manager 144. WB 308 may include information indicating success or failure, the steps it took to attempt completing the task, and the time required. Additional information may also optionally be included, such as results that may be translated and stored in a database for later retrieval by a supervising human worker.

Bot manager 146 handles assignment constraints, such as whether certain bots should be assigned certain tasks. Certain bots may be assigned work tasks based on capabilities and priorities. Additionally, bot manager 146 may inform event manager 144 about the task assignment to WB 308, so that event manager 144 knows to expect a ping or update from WB 308. Upon successfully receiving an indication that WB 308 has begun the task, event manager 144 updates rules engine instance 304 to prevent duplicate assignment of the exception queue task to another WB.

Some possible variations of the process described for FIG. 3 may include that the priority of the task may be related to the dollar amount associated with an unmatched invoice or received item, and a time interval T for WB 308 to report or complete a task may be lengthened or shortened based upon that priority. In addition to the invoicing exception example just described, a bot may also process human worker time clock exceptions, such as when an employee forgets to clock out for lunch. Other types of events or data may also be processed.

FIG. 4A is an exemplary chart illustrating a possible work assignment process flow 400. In FIG. 4A, an example of invoice data 402, such as perhaps contained in an invoice database, is to be processed for exceptions (perhaps similarly as described for FIG. 3). FIG. 4A illustrates the scenario of multiple instances of bot bosses 410, 420, and 430, managing different bot farms 412, 422, and 432. That is, some bots may control the actions of the other bots, and function similarly to some portions of the functionality of bot manager 146 (of FIGS. 1 and 3).

As illustrated bot farm 412 comprises three bots 414, 416, and 418; bot farm 422 comprises three bots 424, 426, and 428; and bot farm 432 comprises three bots 434, 436, and 438. Any of bots 410, 414, 416, 418, 420, 424, 426, 428, 430, 434, 436, and 438 may be stored in WB library 150 (of FIG. 1) and may further be similar to any of bots 204a, 204b, and 308 (of FIG. 2 and FIG. 3). The bots in bot farms 412, 422, and 432 are WBs and interface with legacy systems 419, 429, and 439 respectively. Legacy systems 419, 429, and 439 may include invoicing systems, receiving tracking systems, employee timekeeping systems, and other systems used in running business enterprises or operations. Information flows notionally downward in FIG. 4A, from invoice data 402; through bot bosses 410, 420, and 430, then through bot farms 412, 422, and 432; and finally into legacy systems 419, 429, and 439.

FIG. 4B is an exemplary flow chart illustrating a method 450 that may be used to accomplish the work assignment process of FIG. 4A. Method 450 begins with staging data in box 452, such as by placing data into invoice data 402, or another database or memory location. Data is then distributed, such as to boss bots 410, 420, and 430, in process box 454. The work queue is then built in process box 456. Idle bots are identified in process box 458, possibly by bot performance management 124 (of FIG. 1) keeping track of which bots have which task assignments (and finding a botID that does not correspond to an active task) or by the bots identifying themselves as idle by requesting tasks. Tasks are assigned to particular bots, such as the WBs in bot farms 412, 422, and 432, in process box 460. Also occurring in process box 460 is translation, from a standard data and protocol format to the particular command and control formats needed by the selected WBs. That is the tasks and commands may be translated uniquely to each WB, with different WBs having different translations. The work is then performed by the WBs in box 462. Initially, a WB may send a confirmation that the task is started, and this response may be translated and stored. This way, the bot manager, bot boss, or event manager knows to check health status. In process box 464, bot health is monitored, possibly as described above for FIG. 3, where at least one of health monitor 126 (of FIG. 1), bot manager 146 or event manager 144, or even a bot boss, track responsiveness of the WBs. So long as the WBs stay healthy, when tasks are completed, results are provided, such as resolutions to exception issues experienced by legacy systems 419, 429, and 439, in box 466. The reported data is translated from the particular format of the individual WBs (which may be different among different WBs) to a standard format for storing in a database.

FIG. 5 is an exemplary block diagram 500 illustrating message routing during an alert condition. In some examples, a health check may be performed on bots with event manager 144, a health monitor 126 (both of FIG. 1), or a bot boss. Perhaps an event API has a configurable interval of time for an event log (ping) from each bot, or a bot boss may have been configured with a time interval T for performing periodic checks. If a WB does not respond at an expected interval, the bot boss will send an alert to an alert manager or alert rules engine (a.k.a. an alert queue), possibly via a health monitor. The periodic health checks may be initiated by a WB itself (such as the WB may ping a health monitor, an event manager, boss bot, or bot manager on regular intervals); or may be initiated by an event manager, boss bot, or bot manager, and the WB responds to the ping). Alternatively, health checks may be accomplished by a combination in which an event manager, boss bot, or bot manager expects a ping on regular intervals, and if one is missed, then pings the WB and waits for a response.

In some examples, an alert manager may include a set of response rules such as:
1. Evaluate the prioritization of the task assigned to the non-responsive WB.
2. Evaluate how many times a bot manager or bot boss (or other module) has tried to ping the WB without a response.
3. Analyze rules for restarting the WB.
4. If a restart is properly warranted, a Med Bot restarts the WB.
   a. If restart is successful:
      i. Clear alerts/alarms.
      ii. Done.
   a. If restart is not successful:
      i. Send page out alert.
      ii. Return the task to the work que for another WB to take up.
      iii. The returned task may be assigned a higher priority, based on elapsed time.
      iv. Done.

In the illustration of FIG. 5, a bot boss 502, which may be similar to any of bot bosses 410, 420 or 430 of FIG. 4A, is managing and in communication with four WBs, 504, 506, 508, and 510. As illustrated, the communication between bot boss 502 and each of WBs 504, 508, and 510 is bi-directional. That is, bot boss 502 both sends instructions and receives pings, replies, or updates. Also illustrated in FIG. 5 is that the communication between bot boss 502 and WB 506 is one-way. That is, bot boss 506 no longer receives pings, replies, or updates from WB 506.

As a result of the missed update (or ping response), bot boss 502 sends a message that WB 506 is unresponsive to alert manager 134, possibly directly, or otherwise perhaps through an event manager or a health monitor. Although FIG. 5 is illustrated using a bot boss, the alert reporting functionality described as being performed by bot boss 502 may instead be performed by a bot manager or an event manager (such as bot manager 146 or event manager 144 of FIG. 1)

FIG. 6A is an exemplary flow chart illustrating a method 600 that may be used to respond to the alert condition illustrated in FIG. 5. In some examples, method 600 follows a branch of process box 464 of method 450 (see FIG. 4B), with detection of a non-responsive bot, in process box 602 of method 600. That is, the non-responsiveness is detected while performing the health monitoring of process box 464 (of FIG. 4B). Responsive to detecting non-responsiveness of a bot, an alert is sent in box 604. An alert manager, or other suitable logic, evaluates the prioritization of the task that had been assigned to the non-responsive bot, in process box 606. In box 608, the number of times the bot has failed to respond is evaluated and, if the number is sufficiently high, a med bot is activated. The rules for restarting the non-responsive bot are evaluated in process box 610, and if restart is warranted, the med bot attempts a restart of the non-responsive bot.

If the med bot is successful (as determined in decision 612) the alert is cleared in box 614. If, however, the restart is unsuccessful, a page out alert is issued in box 616, the unfinished task is returned to the work queue in process box 618, and the prioritization of the task is evaluated in process box 620. The priority may be elevated (changed) to a higher category, or may remain within the same category, but with a FIFO priority based on the original timestamp of when it first entered the work queue, rather than a reentry timestamp. Method 600 then ends (for the restart failure case) with the bot manager entering process box 458 of method 450 (of FIG. 4B) to identify an idle WB (possibly using performance management 124 of FIG. 1, or waiting for an idle WB to identify itself by requesting a task) to take up the uncompleted task.

FIG. 6B is an exemplary block diagram 600b illustrating a failure to restart bot 506, after the initial alert condition illustrated in FIG. 5. As shown in FIG. 6B, alert manager 134 spawned a med bot 620 that used restart logic 632 to ascertain that a restart was warranted, and then attempted a restart. Because the restart was unsuccessful, a page out alert 624 was issued. The follow-up message to issue the page out alert may come from any of bot boss 502, med bot 630, or restart logic 632, depending on the particular configuration of the embodiment. In some situations, further intervention may be required to restore the system to proper functionality.

FIG. 6C is an exemplary block diagram 600c illustrating a successful restart of bot 506, after the initial alert condition illustrated in FIG. 5. As shown in FIG. 6C, alert manager 134 spawned med bot 620 that used restart logic 632 to ascertain that a restart was warranted, and then attempted a restart. Because the restart was successful, bot 506 began communicating with bot boss 502. Bot boss 502 then sends out a message to clear or cancel the alert/alarm for bot 506.

In some examples, the operations illustrated in FIG. 4B and FIG. 6A may be implemented as software instructions encoded on a computer-readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples is also within scope of the aspects of the disclosure.

### Exemplary Operating Environment

FIG. 7 is an exemplary block diagram illustrating an operating environment 700 for a computing device implementing RPA. For example, computing device 102 of FIG. 1 may be implemented as environment 700. The computing system environment 700 is only one example of a suitable computing environment and is not intended to suggest any limitation as to the scope of use or functionality of the disclosure. Neither should the computing environment 700 be interpreted as having any dependency or requirement relating to any one or combination of components illustrated in the exemplary operating environment 700.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 7, an exemplary system for implementing various aspects of the disclosure may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media may be any available media that may be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 731 and 732 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 710. Computer storage media does not, however, include propagated signals. Rather, computer storage media excludes propagated signals. Any such computer storage media may be part of computer 710.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs, such as optimization environment 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a universal serial bus (USB) port 751 that provides for reads from or writes to a removable, nonvolatile memory 752, and an optical disk drive 755 that reads from or writes to a removable, nonvolatile optical disk 756 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and USB port 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, optimization environment 745, other program modules 746 and program data 747. Note that these components may either be the same as or different from operating system 734, optimization environment 735, other program modules 736, and program data 737. Operating system 744, optimization environment 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel may be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

### Exemplary Operating Methods and Systems

An exemplary method for managing RPA bots implemented on at least one processor may comprise: assigning a first task from a work queue to a first bot, using a first translation; assigning a second task from the work queue to a second bot, using a second translation different from the first translation; receiving data from the first bot; responsive to receiving data from the first bot, translating the received data from the first bot using a third translation different from the second translation; storing the translated data from the first bot on a non-transitory computer-readable medium; receiving data from the second bot; responsive to receiving data from the second bot, translating the received data from the second bot using a fourth translation different from the first and third translations; and storing the translated data from the second bot on the non-transitory computer-readable medium.

The method may further comprise monitoring health of the first and second bot; and responsive to detecting non-responsiveness of the first bot, sending a first alert. The method may further comprise responsive to detecting non-responsiveness of the first bot, attempting to restart the first bot. The method may further comprise determining whether the attempted restart of the first bot is successful; and responsive to determining that the attempted restart of the first bot is not successful, returning the first task to the work queue. The method may further comprise responsive to determining that the attempted restart of the first bot is not successful, determining whether the second bot is idle; and responsive to determining that the second bot is idle, assigning the first task to the second bot, using the second translation. The method may further comprise responsive to determining that the attempted restart of the first bot is not successful, sending a second alert; and changing a priority of the first task in the work queue. The method may further comprise determining whether the attempted restart of the first bot is successful; and responsive to determining that the attempted restart of the first bot is successful, clearing the first alert. The method may further comprise evaluating a priority of the first task; activating a med bot; and analyzing rules for restarting the first bot. Translating data received from a bot optionally comprises translating data into a standard format.

Another method for managing RPA bots implemented on at least one processor may comprise: assigning a first task from a work queue to a first bot, using a first translation; assigning a second task from the work queue to a second bot, using a second translation different from the first translation; receiving data from the first bot; responsive to receiving data from the first bot, translating the received data from the first bot into a standard format using a third translation different from the second translation; storing the translated data from the first bot on a non-transitory computer-readable medium; receiving data from the second bot; responsive to receiving data from the second bot, translating the received data from the second bot into the standard format using a fourth translation different from the first and third translations; storing the translated data from the second bot on the non-transitory computer-readable medium; monitoring health of the first and second bot; and responsive to detecting non-responsiveness of the first bot: sending a first alert; attempting to restart the first bot; determining whether the attempted restart of the first bot is successful; responsive to determining that the attempted restart of the first bot is successful, clearing the first alert; and responsive to determining that the attempted restart of the first bot is not successful: sending a second alert; returning the first task to the work queue; determining whether the second bot is idle; and responsive to determining that the second bot is idle, assigning the first task to the second bot, using the second translation.

A system for managing RPA bots implemented on at least one processor may comprise: a processor; and a non-transitory computer-readable medium storing instructions that are operative when executed by the processor, the instructions comprising logic for implementing any of the methods or processes disclosed herein.

Alternatively, or in addition to the other examples described herein, examples include any combination of the following:
monitoring health of the first and second bot;
responsive to detecting non-responsiveness of the first bot, sending a first alert;
responsive to detecting non-responsiveness of the first bot, attempting to restart the first bot;
determining whether the attempted restart of the first bot is successful;
responsive to determining that the attempted restart of the first bot is not successful, returning the first task to the work queue;
responsive to determining that the attempted restart of the first bot is not successful, determining whether the second bot is idle;
responsive to determining that the second bot is idle, assigning the first task to the second bot, using the second translation;
responsive to determining that the attempted restart of the first bot is not successful, sending a second alert;
changing a priority of the first task in the work queue;
responsive to determining that the attempted restart of the first bot is successful, clearing the first alert.
evaluating a priority of the first task;
activating a med bot;
analyzing rules for restarting the first bot; and
wherein translating data received from a bot comprises translating data into a standard format.

The examples illustrated and described herein as well as examples not specifically described herein but within the scope of aspects of the disclosure constitute an exemplary entity-specific value optimization environment. The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for managing robotic process automation (RPA) software robots (bots) implemented on at least one processor, the system comprising:
a processor; and
a non-transitory computer-readable medium storing instructions that are operative when executed by the processor, the instructions comprising logic for:
assigning a first task from a work queue to a first bot, using a first translation;
assigning a second task from the work queue to a second bot, using a second translation different from the first translation;
receiving data from the first bot;
responsive to receiving data from the first bot, translating the received data from the first bot using a third translation different from the second translation;
storing the translated data from the first bot on the non-transitory computer-readable medium;
receiving data from the second bot;
responsive to receiving data from the second bot, translating the received data from the second bot using a fourth translation different from the first and third translations; and
storing the translated data from the second bot on the non-transitory computer-readable medium.

2. The system of claim 1 wherein the instructions further comprise logic for:
monitoring health of the first and second bot; and
responsive to detecting non-responsiveness of the first bot, sending a first alert.

3. The system of claim 2 wherein the instructions further comprise logic for:
responsive to detecting non-responsiveness of the first bot, attempting to restart the first bot.

4. The system of claim 3 wherein the instructions further comprise logic for:
determining whether the attempted restart of the first bot is successful; and
responsive to determining that the attempted restart of the first bot is not successful, returning the first task to the work queue.

5. The system of claim 4 wherein the instructions further comprise logic for:
responsive to determining that the attempted restart of the first bot is not successful,
determining whether the second bot is idle; and
responsive to determining that the second bot is idle, assigning the first task to the second bot, using the second translation.

6. The system of claim 4 wherein the instructions further comprise logic for:
responsive to determining that the attempted restart of the first bot is not successful, sending a second alert; and
changing a priority of the first task in the work queue.

7. The system of claim 3 wherein the instructions further comprise logic for:
determining whether the attempted restart of the first bot is successful; and
responsive to determining that the attempted restart of the first bot is successful, clearing the first alert.

8. The system of claim 2 wherein the instructions further comprise logic for:
evaluating a priority of the first task;
activating a med bot; and
analyzing rules for restarting the first bot.

9. The system of claim 1 wherein translating data received from a bot comprises translating data into a standard format.

10. A method for managing robotic process automation (RPA) software robots (bots) implemented on at least one processor, the method comprising:
assigning a first task from a work queue to a first bot, using a first translation;
assigning a second task from the work queue to a second bot, using a second translation different from the first translation;
receiving data from the first bot;
responsive to receiving data from the first bot, translating the received data from the first bot using a third translation different from the second translation;
storing the translated data from the first bot on a non-transitory computer-readable medium;
receiving data from the second bot;
responsive to receiving data from the second bot, translating the received data from the second bot using a fourth translation different from the first and third translations; and
storing the translated data from the second bot on the non-transitory computer-readable medium.

11. The method of claim 10 further comprising:
monitoring health of the first and second bot; and
responsive to detecting non-responsiveness of the first bot, sending a first alert.

12. The method of claim 11 further comprising:
responsive to detecting non-responsiveness of the first bot, attempting to restart the first bot.

13. The method of claim 12 further comprising:
determining whether the attempted restart of the first bot is successful; and
responsive to determining that the attempted restart of the first bot is not successful, returning the first task to the work queue.

14. The method of claim 13 further comprising:
responsive to determining that the attempted restart of the first bot is not successful,
determining whether the second bot is idle; and
responsive to determining that the second bot is idle, assigning the first task to the second bot, using the second translation.

15. The method of claim 13 further comprising:
responsive to determining that the attempted restart of the first bot is not successful, sending a second alert; and
changing a priority of the first task in the work queue.

16. The method of claim 12 further comprising:
determining whether the attempted restart of the first bot is successful; and
responsive to determining that the attempted restart of the first bot is successful, clearing the first alert.

17. The method of claim 11 further comprising:
evaluating a priority of the first task;
activating a med bot; and
analyzing rules for restarting the first bot.

18. The method of claim 10 wherein translating data received from a bot comprises translating data into a standard format.

19. One or more computer storage devices having computer-executable instructions stored thereon for managing robotic process automation (RPA) software robots (bots), which, on execution by a computer, cause the computer to perform operations comprising:
assigning a first task from a work queue to a first bot, using a first translation;
assigning a second task from the work queue to a second bot, using a second translation different from the first translation;
receiving data from the first bot;
responsive to receiving data from the first bot, translating the received data from the first bot into a standard format using a third translation different from the second translation;
storing the translated data from the first bot on a non-transitory computer-readable medium;
receiving data from the second bot;
responsive to receiving data from the second bot, translating the received data from the second bot into the standard format using a fourth translation different from the first and third translations;
storing the translated data from the second bot on the non-transitory computer-readable medium;
monitoring health of the first and second bot; and
responsive to detecting non-responsiveness of the first bot:
sending a first alert;
attempting to restart the first bot;
determining whether the attempted restart of the first bot is successful;
responsive to determining that the attempted restart of the first bot is successful, clearing the first alert; and
responsive to determining that the attempted restart of the first bot is not successful:
sending a second alert;
returning the first task to the work queue;
determining whether the second bot is idle; and
responsive to determining that the second bot is idle, assigning the first task to the second bot, using the second translation.

20. The one or more computer storage devices of claim 16, wherein the operations further comprise:
evaluating a priority of the first task;
activating a med bot; and
analyzing rules for restarting the first bot.
